(19) United States
(12) Patent Application Publication
(10) Pub. No.: US 2007/0000402 A1
(43) Pub. Date: Jan. 4, 2007

(54) Digital workflow processes for generating product proofs

(76) Inventor: Timothy J. Abrott, Federal Way, WA (US)

Correspondence Address: WEYERHAEUSER COMPANY;INTELLECTUAL PROPERTY DEPT., CH 1J27, P.O. BOX 9777, FEDERAL WAY, WA, 98063, US

(21) Appl. No.: 11/171,019

(22) Filed: Jun. 30, 2005

(51) Int. Cl. B41F 33/00

(52) U.S. Cl. 101/483

(57) ABSTRACT

Embodiments of the present invention provide digital workflow methods for generating product proofs that achieve the benefits of digital printing, including lower costs, and less production time, while also providing an appearance that accurately resembles the final product printed on, for example, conventional contact printing presses.

### FIELD OF THE INVENTION

Embodiments of the present invention relate generally to digital printing, and in particular, to systems and methods for generating proofs in a digital workflow.

### BACKGROUND OF THE INVENTION

Proofs have been utilized in the printing industry for a long time. Typically, proofs are test sheets that are generated to reveal errors or flaws, check color, predict results, and record how a printing job is intended to appear. Proofs can be printed on a proof press or on the actual press that the job is intended to be printed. Proof sheets or progressive proofs may be generated, if desired by the customer, or a composite proof can be made with the press on which the job will be printed. In most cases, it is desirable for the proof to be printed on the actual substrate selected for the job.

Conventional proofing methods are quite expensive and can require a substantial amount of time to create after the prepress work is completed. Therefore, in recent years, the industry has been turning to digital proofing techniques, which are capable of lower production costs and shorter cycle times, to encompass an entirely digital workflow. This, however, has not been without its problems. For example, digital printing processes, including ink jet, electrophotography, etc. can have print appearances that differ substantially from the appearance of products printed using conventional contact printing techniques, such as lithography, flexography, and rotogravure. This can occur do to the “fingerprints”, also known as artifacts or appearance effects, that contact printing techniques add to the printed image based on the physical design or limitations of the press (e.g., uneven pressure applied on the plates, uneven ink distribution, etc.). These differences can be highly undesirable, especially is the differences are clearly noticeable to the customer.

### SUMMARY OF THE INVENTION

Embodiments of the present invention address the deficiencies of the prior art and others by providing digital workflow methods for generating product proofs that achieve the benefits of digital printing, including lower costs, and less production time, while also providing an appearance that accurately resembles the final print product printed on, for example, conventional contact printing presses.

In accordance with aspects of the present invention, a method of generating proof data is provided. The proof data is used to digitally print a product proof. The method comprises obtaining a digital image and applying at least one digital filter to the digital image. The digital filter alters the digital image to simulate at least one appearance effect indicative of a printing process.

In accordance with another aspect of the present invention, a method for generating a product proof on a digital output device is provided. The method comprises obtaining a digital image, selecting at least one digital filter to apply to the digital image based on selected criteria, and filtering the digital image by the selected at least one filter to alter the digital image for creating proof data. The proof data includes at least one print appearance attribute of contact printing.

In accordance with another aspect of the present invention, a method of utilizing a digital prepress workflow to aid in customer decision making is provided. The method comprises obtaining one or more customer design parameters associated with a print job, generating a source image according to at least one of the customer parameters, and generating a set of modified images from the source image by applying one or more filters to the source image. Each modified image of the set simulates at least one print appearance affect of printing on a selected output device that is different than the output device chosen for generating the set of proofs. The method further comprises printing the modified images as a set of proofs on the chosen digital printing device.

### BRIEF DESCRIPTION OF THE DRAWINGS

The foregoing aspects and many of the attendant advantages of this invention will become more readily appreciated by reference to the following detailed description, when taken in conjunction with the accompanying drawings, wherein:

FIG. 1 is a flow diagram depicting one illustrative embodiment of a digital workflow process formed in accordance with aspects of the present invention for generating a product proof according to a customer's instructions, wherein the workflow process generates digital proof data that, when printed using an appropriate image output device, such as a digital inkjet, laser, or electrographic printer, simulates the appearance of the source image printed on one of many conventional printing apparatuses, such as flexographic, lithographic, or gravure printing presses;

FIG. 2 is an illustrative subprocess for generating an artwork file according to the customer's instructions;

FIG. 3 is an illustrative subprocess for processing an artwork file to create proof data; and

FIG. 4 is a block diagram of one suitable computer system in which embodiments of the present invention may be implemented in accordance with aspects of the present invention.

### DETAILED DESCRIPTION OF THE PREFERRED EMBODIMENT

Embodiments of the present invention will now be described with reference to the accompanying drawings where like numerals correspond to like elements. The following description provides examples of a digital prepress workflow process for generating proof data and for printing said proof data on a selected substrate. The following examples generally described processes for digitally generating product proofs that resemble product proofs that would have been otherwise printed conventionally using contact printing presses, such as flexographic, lithographic, or gravure printing presses. However, it should be apparent that these examples are only illustrative in nature and should not be considered as limiting the embodiments of the present invention, as claimed.

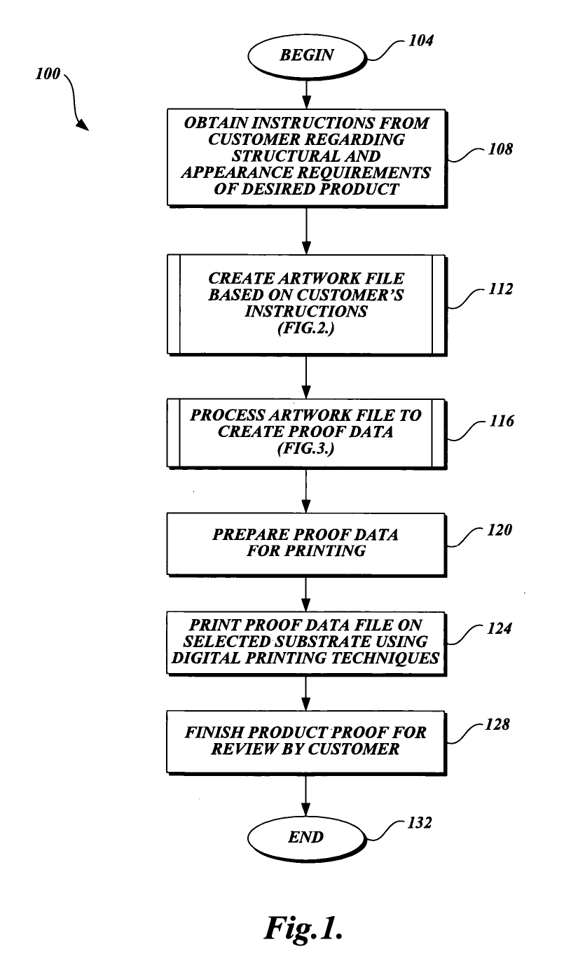

Referring now to FIG. 1, there is shown a flow diagram depicting one exemplary digital workflow process, generally designated 100, which is formed in accordance with aspects of the present invention for generating a product proof according to a customer's instructions. The generated product proof(s) potentially provides lower costs and shorter product cycle times. As will be described in more detail below, a set of proofs may also be generated having different appearances so that the customer can appreciate how the product will appear using different printing methods. Other embodiments may utilize one or more proofs as marketing, promotional, and sales materials.

Generally described, the process 100 begins at block 104 and proceeds to block 108 where a graphic designer obtains instructions from a customer desiring a custom product with graphical images to be printed thereon, such as a package, packaging display, shipping container, or the like. The instructions obtained from the customer includes the structural requirements for the product and the graphical requirements for the artwork to appear on the product. For example, the customer may have specific images, logos, and/or text in mind to be used, or the customer may have a general concept in mind for the graphics designer to further develop. The instructions may specify the ink type, colors, substrates, etc. to be used. As will be described in more detail below, the customer may also specify the printing method to be used, such as preprint or postprint flexography or lithography.

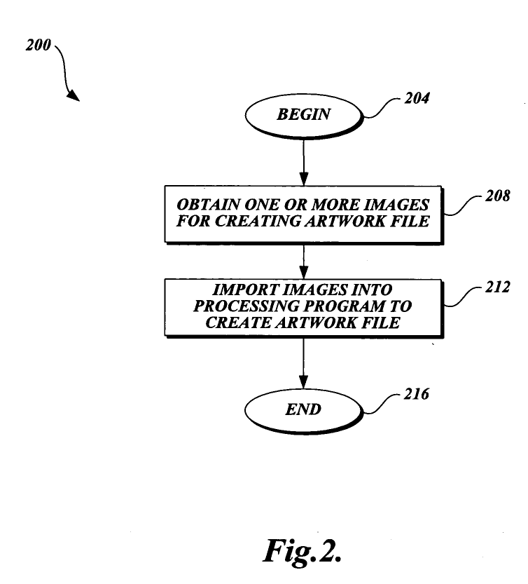

After the instructions from the customer are obtained at block 108, the process proceeds to block 112. At block 112, the graphic designer creates a digital artwork file based on the customer's instructions that will be printed on the product. As will be described in more detail below with reference to FIG. 2, the digital artwork file is generated in a conventional computer system using conventional desktop publishing software programs, such as Adobe Photoshop®, Adobe Illustrator®, Adobe PageMaker®, QuarkXPress™, CorelDraw®, Macromedia Freehand®, etc., or combinations thereof, and may be stored on any conventional computer readable media, some of which are described in detail below. The term desktop publishing program is used herein to include all programs, such as image processing programs, image creation programs, and page creation programs, that are employed, for example, in the desktop publishing, graphic arts, or engineering drawing industries.

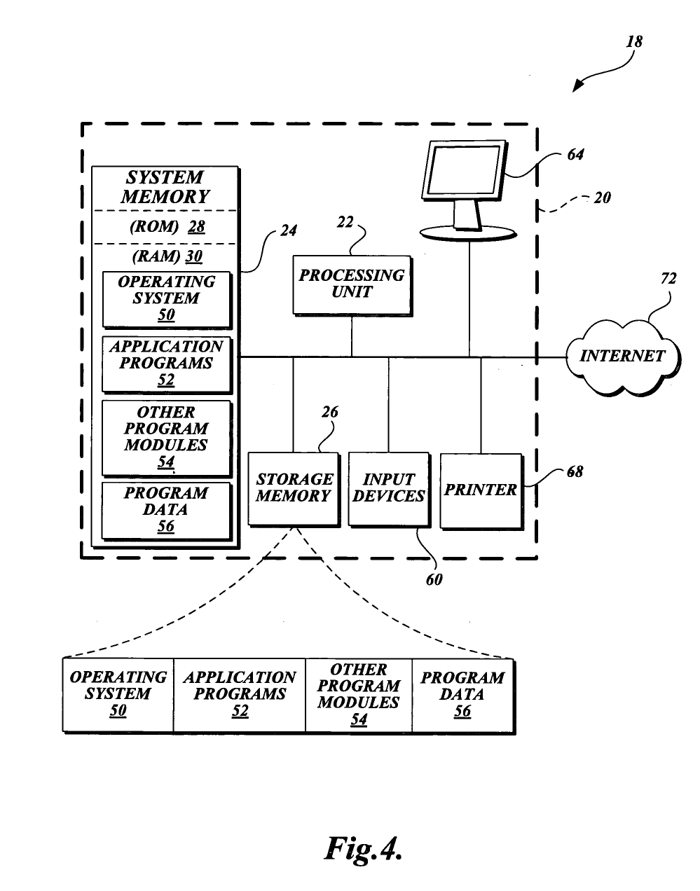

One suitable computer system 18 in which embodiments of the present invention may be implemented is illustrated as a block diagram in FIG. 4. Although not required, aspects of the present invention will be described in the general context of computer-executable instructions, such as program modules, being executed by a personal computer and stored, for example, on computer readable media, as will be described below. Generally, program modules include routines, programs, objects, components, data structures, etc. that perform particular tasks or implement particular abstract data types.

The conventional computing system 18 includes a general computer 20, including a processing unit 22, a system memory 24, and a storage memory 26 suitable interconnected. The system memory 24 includes read only memory (ROM) 28 and random access memory (RAM) 30, and the storage memory may include hard disk drives for reading from and writing to a hard disk, a magnetic disk drive for reading from or writing to a removable magnetic disk, and an optical disk drive for reading from or writing to a removable optical disk, such as a CD, DVD or other optical media. The storage memory and their associated computer-readable media provide non-volatile storage of computer readable instruction, data structures, program modules and other data for the computer 20. Other types of computer readable media which can store data that is accessible by a computer, such as magnetic cassettes, flash memory cards, digital video disks, Bernoulli cartridges, random access memories (RAMs), read only memories (ROMs), and the like, may also be used in the exemplary computer system.

A number of program modules may be stored on the storage memory 26 or system memory 24, including an operating system 50, one or more application programs 52, including desktop publishing programs, such as Adobe Photoshop®, Adobe PageMaker®, Adobe Illustrator®, QuarkXPress™, CorelDraw®, Macromedia Freehand®, etc., printing preparation programs, etc., other program modules 54, such as color ink jet drivers, color management and/or image reproduction adjusting filters, and program data 56. The computing system 18 may further include input devices 60, such as a keyboard, a pointing device, a scanner, or the like, suitable connected through appropriate interfaces, such as serial ports, parallel ports or a universal serial bus (USB). A monitor 64 or other type of display device is also included. In addition to the monitor, the computer system also includes other peripheral output devices, such as a color ink jet printer 68.

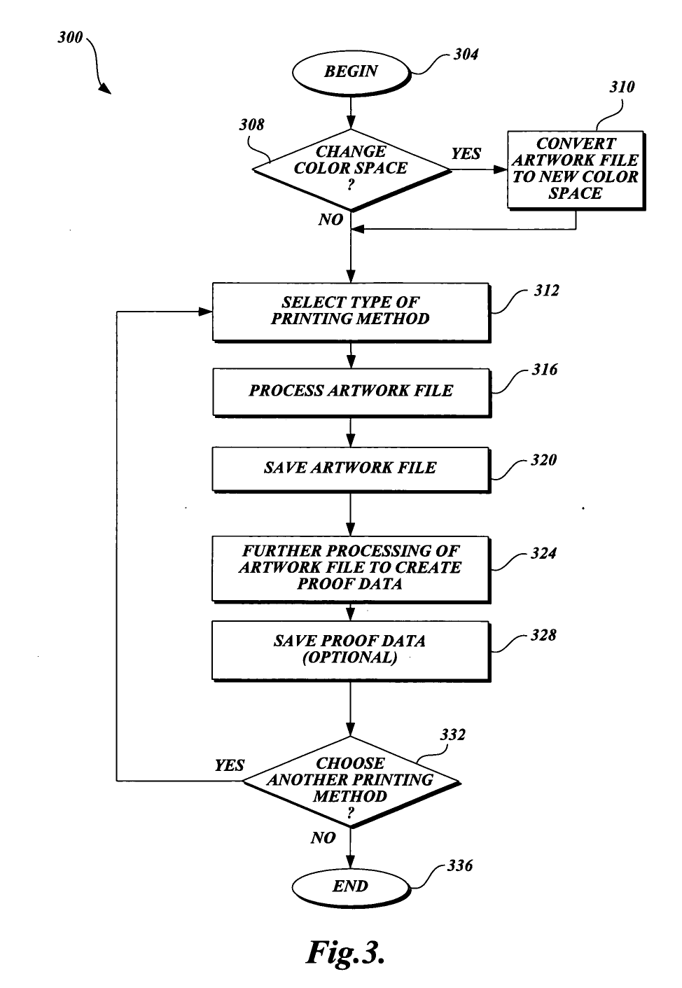

Next, the artwork file is processed for creating proof data at block 116 based, for example, on a customer's instructions. As will be described in more detail below with reference to FIG. 3, the digital artwork file is processed in a conventional computer system using conventional desktop publishing programs, such as Adobe Photoshop®, Adobe PageMaker®, Adobe Illustrator®, QuarkXPress™, CorelDraw®, Macromedia Freehand®, etc. or combinations thereof. The processing step may include color management techniques and/or image reproduction adjustment techniques, as will be described in more detail below.

After the proof data is created from the artwork file, the proof data is prepared for printing at block 116. This may occur at the computer system 18 running the desktop publishing program(s), a separate printing workstation, a print server, or other known device that is capable of appropriately preparing the proof data to be printed on a selected digital output device, such as an ink jet printer, laser printer, electrographic printer, etc. This process may involve, for example, converting the file into an appropriate file format, such as a Postscript file, creating color separations, and/or converting the continuous tone image into a bitmap image using conventional half-tone screening techniques. In several embodiments, the proof data is processed to create, for example, digital ink jet printing instructions, which will apply inks or toners onto the substrate in the specified locations and sequences as required to achieve the specified design appearance of the proof data.

Once the proof data is prepared for printing, the proof data may then be printed on a selected substrate using digital printing techniques, such as ink jet printers, laser jet printers, electrographic devices, etc., at block 120. In several embodiments of the present invention, the selected substrate is identical or substantially identical to the substrate that will be used for the final product for improving the accuracy of the product proof. As was described above, the substrate selection may be one specified by the customer. In embodiments of the present invention, the substrate may be any container blank or container suitable for use in the packaging, shipping, storing or displaying industry. Several examples of a substrate that may be practiced with the present invention include but are not limited to containerboard, fiberboard, linerboard, cardboard, paperboard, corrugated board, and styrene. At block 124, the printed proof may then be finished, such as scored, cut, slotted, folded, glued, etc. in order to complete the product proof for review by the customer. The process 100 ends at block 128.

Referring now to FIG. 2, an illustrative subprocess 200 for generating an artwork file according to the customer's instructions will be described in detail. The subprocess 200 begins at block 204 and proceeds to block 208, where one or more composite images that are desired by the customer are obtained. For example, the images may be a natural scene containing complex content, e.g. a photographic image, or may simply be line art or drawn illustrations, such as a company logo. The images may be, for example, any conventionally encoded digital image, preferably 8 or 16 bit, in one of many color image formats, such as “RGB” (a 3-color system including red (“R”), green (“G”), and blue (“B”)), “CMY” (a 3-color system including cyan (“C”), magenta (“M”), and yellow (“Y”)), or “CMYK” (a 4-color system including the “CMY” colors and black (“K”)), or in black and white format.

One or more of the images can be transferred as digital images into the computer memory 24 and/or 26 of the computer system 18, an example of which is described with reference to FIG. 4, using any one of numerous means of transferring a document into computer memory. For example, the images may be downloaded from a secondary source, such as the Internet 72, a CD-ROM, DVD-ROM, flash memory or other digital storage means, or a digital camera. Alternatively, one or more of the images may be created in the computer system by using a commercially available desktop publishing program, such as Adobe Illustrator® or Macromedia Freehand®, which may be stored in the computer memory. One or more of the images may also be obtained by digitally scanning a printed image using a scanner suitable connected to the computer system as well known in the art. In one example hereinafter described, the images are RGB encoded digital images capable of being viewed on an additive color system using the computer system with a CRT monitor or equivalent display device.

The process 200 then proceeds to block 212, where the image or images may be imported into a newly created file of a conventional desktop publishing program, such as Adobe Photoshop®, Adobe PageMaker®, Adobe Illustrator®, QuarkXPress™, CorelDraw®, Macromedia Freehand®, etc., executed on the computer system. The image or composition of more than one image in the newly created file will be hereinafter referred to as the artwork file. The desktop publishing software programs, when executed, enables the artwork file to be generated, processed, and stored according to user selected commands. The subprocess ends at block 216.

Referring now to FIG. 3, an illustrative subprocess 300 for creating proof data from an artwork file based on a customer's instructions will be described in detail. The subprocess 300 begins at block 304 and proceeds to block 308, where a determination is made whether to change the color space of the artwork file. For example, if the designer wishes to work in the additive color space, such as the RGB color space, or one of the subtractive color spaces, such as CMY or CMYK color space, a color conversion may be necessary depending on the color space of the artwork file. In embodiments where the designer wishes to work in, for example, the CMYK color space, but creates the artwork file in, for example, the RGB color space or vice versa, the subprocess proceeds to block 310 where the designer initiates a color space change within the desktop publishing program for converting the color space of the art file to the desired color space.

In embodiments that employ Adobe Photoshop® to process the artwork file, the conversion is sometimes referred to as a mode change. As such, the desktop publishing program re-expresses an RGB encoded artwork file in, for example, CMYK units; i.e., it yields a CMYK artwork file and four ink separation positives of the artwork file for the cyan, magenta, yellow, and black inks (C, M, Y, K separation positives, sometimes referred to as C, M, Y, K channels) or re-expresses a CMYK encoded artwork file in RGB units, i.e., it yields a RGB artwork file and three channels of the artwork file for the Red, Green, and Blue inks. In embodiments where the color space of the image file and the designer's preference of the color space are the same, no conversion is necessary, and the subprocess proceeds to block 312.

It will be appreciated that in several embodiments, if desired, the RGB artwork file may be readily converted to a CMY or CMYK artwork file and vice versa using complimentary mapping techniques. Alternatively, the artwork file may be converted to other formats, such as a CIE L*a*b* format, using encoding techniques such as look-up table mapping. Complementary mapping generally refers to the color(s) a filter of a given color absorbs. For example, since a red filter passes red (R) light but blocks green and blue light, its complement; i.e., 1-R, yields the amount of non-red light, which is essentially green and blue. Cyan light is a mixture of green and blue light. Look-up table mapping generally refers to the relationship between RGB and CIE L*a*b* color. Other color formats may also be used with embodiments of the present invention. For example, an RGB encoded artwork file may be converted into a color format having five or more inks; e.g., to CMYKabc using International Color Consortium (ICC) profiles or other empirical or model-based conversion methods with CMYK process inks and ink colors “a”, “b”, “c”; or an RGB encoded image may be converted into traditional two (Duotone), three (Tritone) or four-color (Quadtone) printing using commercial or other available conversion methods.

The subprocess then proceeds to block 312, where a printing method is selected based, for example, on the customer's instructions. In some embodiments where the customer has left the decision up to the designer or wanted to see various options, multiple printing methods, chosen one at a time, may be selected as will be described in detail below. The printing method chosen may be, for example, any of the conventional contact printing techniques, such as preprint or postprint flexography, lithography, gravure, etc. Once the printing method is chosen, the subprocess proceeds to block 316, where the artwork file is processed according to the printing method chosen. While the printing method is one exemplary type of workflow criteria, other criteria may be used, such as substrate type and/or ink type, to name a few.

This processing step may include color adjustments, image reproduction adjustments, and/or substrate simulation. The color adjustments may simply be directed to the overall image brightness or contrast, or may be as complex as adjustments to contrast, tonal value, brightness, and color balance at the color separation (e.g., C, M, Y, K) level. The color adjustments may be done manually or the process may be automated through color management filters and settings. It will be appreciated that some color management filters and settings may automatically conduct a color space change. The color adjustments, either done manually or through the application of selected filters and settings, can be based on the particular printing method selected, the experience of the designer or appearance desired by the customer.

The processing at block 316 may also include image reproduction adjustments to achieve a high quality product. Image reproduction adjustments that can be made include but are not limited to half tone screen frequency, screen angles, rosette pattern, moiré patterns, anti-aliasing, misregistration and trapping. Some of these adjustments can be accomplished by user initiated operations while others utilize preconfigured operations, such as filters and settings, that are applied to the artwork file. It will be appreciated that the designer takes into consideration the substrate, inks, as well as the selected printing method and perhaps the specific printing press to be employed to create the image design based on the capabilities of these design parameters to achieve the desired appearance.

The processing at block 316 may further include simulation of substrate type and color. As was described above, a proof is more accurate compared to the final product print if the substrate selected for the final product print is the same, including color, as the one selected for the product proof. Thus, if the substrate employed for the product proof is the same, this substep may be omitted. However, if different substrates are used, based on availability, costs, etc., the artwork file may be further processed to simulate the substrate type and color to improve the accuracy of the product proof. For example, if the proof substrate is white gloss and the final printed product is brown linerboard, the designer may manipulate the artwork file, through, for example, filters, adding color layers, etc., to simulate the substrate of the product print.

The subprocess 300 then proceeds to block 320, where the processed artwork file may be saved in the computer memory for subsequent printing steps or further processing. This saved artwork file is the image data used to print the final product during the full production run. In several embodiments, the artwork file is saved in TIFF format, although other formats may be practiced with the present invention. It will be appreciated that the saved artwork file contains computer executable instructions, which instruct an image to be printed on a selected substrate.

Since digital proofs seldomly appear the same as proofs printed on a conventional contact press, such as a preprint or postprint flexographic press, a lithographic press, a gravure press, etc, in accordance with one aspect of the present invention, the artwork file is further processed in order to achieve a digitally printed proof with an appearance that more closely resembles that achieved by conventional printing methods. To that end, the subprocess 300 then proceeds to block 324, where the saved artwork file may be accessed and further processed, as will now be described in further detail. At block 324, the artwork file is processed by one or more filters selected from a group of filters based on, for example, the selected printing method, other selected criteria discussed above, or combinations thereof. By processing the artwork file with one or more filters, proof data is created.

The filters may be included in one or more of the desktop publishing programs or accessed by a separate program stored or accessible from the computer system. The filters also may be part of a specialized desktop publishing program that could be used to process the artwork files. Alternatively, the processing may occur on a stand-alone workstation, a print server or a digital printer preparation station. The filters may be specific to a printing method, such as flexography, or generic to a printing category, such as contact printing devices. The filters may further be device specific as to a specific manufacturer or brand of a type of printing device. As will be described in detail below, the filters add image data in the form of artifacts to the artwork or alters the artwork file to simulate the appearance effects indicative of specific artifacts or appearances that are added to or formed on the printed product by contact printing methods.

Examples of the filters that may be practiced with the present invention will now be described in more detail; however, other filters for simulating print artifacts or appearance affects from conventional printing presses may be practiced with and are therefore considered to be within the scope of the present invention. The first example of a filter that may be employed is a mottling filter. Mottling refers to the condition characterized by non-uniformity in a printed image that involves variations in solid and/or non-solid print areas. Mottling can appear as variations in print coverage, printed color, gloss reflectance and/or printed dot growth. Print coverage refers to the presence of print defects, for instance, unprinted specks within a solid print area. Printed color includes attributes of lightness (darker or lighter), chroma (lower or higher saturation) and hue (warmer or colder). Gloss reflectance refers to the specular light reflected at a gloss viewing angle. Printed dot growth describes the increase in halftone dot size during ink transfer in a contact printing process. One or more of these print attributes may vary due to mottling, thereby affecting the visual appearance uniformity of the printed image.

Mottling is typically caused by spatial differences in ink transfer, printing pressure and/or ink absorption that can vary from location to location on the substrate during the printing process. For instance, a substrate may vary in thickness. A high thickness location may be smoother, due to more effective smoothing during the production process, while a low thickness location is rougher due to limited smoothing. During contact printing, ink transfers at a higher printing pressure onto the high thickness locations. In addition, the ink transfers as a smoother layer and is absorbed less into the substrate due to the smoother surface. Print coverage, printed color and gloss reflectance all tend toward higher levels where the substrate thickness is higher. Conversely, the opposite effects may occur in a lower thickness location due to the lower printing pressure and poorer surface smoothness. The spatial differences in these print attributes lead to the visual printed appearance variation referred to as mottling. Thus, the mottling filter manipulates the artwork file to depict random non-uniformity of ink in a printed image in solid and/or non-solid print areas of the artwork file.

The second example of a filter that may be employed in embodiments of the present invention is an “ink squeeze out” filter. Ink squeeze-out refers to the condition characterized by the growth of solid and non-solid print areas due to contact printing pressure, especially in flexographic printing. While ink squeeze-out can occur differentially as mottling on the substrate surface, this term is meant to refer to global ink squeeze-out changes. In flexographic or lithographic printing, the printing ink layer resides on the surface of printing plates. The ink is then pressed against the substrate surface by applying pressure to the printing plate in the printing nip, and the ink is squeezed out between the printing plate and substrate surfaces.

Depending on ink conditions, the ink may flow laterally at the edges of one or more printed image elements formed in the plates (i.e., solid print areas, text characters, bar code bars, etc.) As printing pressure or ink “flowability” increases, ink will flow laterally at the print element edges in the printing nip. This lateral flow results in a larger growth along the edges of solid and non-solid print elements. This may cause a condition, for example, in flexographic presses, characterized by a “halo” appearance with a darker outer growth boundary and a lighter inner growth band surrounding the intended image element print. In other contact presses, this may cause poor edge sharpness in the printed images. Higher printing pressure or a more flowable ink will increase this squeeze out effect, while opposite conditions will decrease this effect. Ink squeeze-out can particularly degrade a printed item by filling in text and bar codes, darkening halftone images and making print edges less sharp. Thus, the “ink squeeze out” filter manipulates the artwork file to blur the edges of various images or produces a haloing effect if flexographic printing has been selected.

The third example of a filter that may be employed is a washboarding filter. Washboarding refers to a condition characterized by the appearance of alternating darker and lighter bars when images are printed via a contact printing process on corrugated substrates. The bars are elongated in the fluting direction and are caused by ink transfer differences associated with the corrugated fluting. The flute tips, locations where the print surface linerboard is glued in direct contact with the fluted corrugating medium, often have darker printed color and fewer print defects. Flute valleys, where the print surface linerboard is not in direct contact with the corrugating medium, often have lighter printed color and more print defects.

Differential ink transfer between the flute tips and valleys may be caused by the application of greater printing pressure by the contact printing press at the flute tips due to their greater rigidity. Additionally, the flute valleys may be depressed somewhat from the flute tips through localized deformations occurring in the corrugation process, which can lead to differential ink transfer. The differential ink transfer results in printed appearance differences across the fluting structure. These differences appear as light and dark bars, with spacing and dimensions related to the corrugated fluting structure. The appearance effects, or washboarding effects, caused by differential ink transfer is most pronounced for flexographic printing and larger fluting structures. Thus, the washboarding filter adds artifacts or appearance effects that resemble alternating darker and lighter bars within the printing image.

After the artwork file has been filtered by the appropriate filter(s), the subprocess 300 then proceeds to block 328, where the processed artwork file, now proof data, may be saved in the computer memory as a separate proof data file for subsequent printing steps. After the proof data file is saved, a decision is made at block 332 as to whether another product proof is desired. For example, a set of competing product proofs may be desired by the customer to aid in the decision making process. If so, the subprocess returns to block 312, if the answer is no, the subprocess ends at block 336.

It will be appreciated that substrates used to created the product proofs in accordance with embodiments of the present invention may employ the full range of corrugated package and display substrate types. All corrugated board structures (fluting, linerboard/medium combinations, etc.) and linerboard types (coated, uncoated, metallized, brown, white, etc.) may be used.

While the embodiments have described herein as generating proofs, other uses of the processes may be realized. For example, embodiments of the processes described herein may be used in creating mock-up or marketing/sales samples for a new product package. By providing mock-ups or samples in this manner, the customer could see and test the designs that simulate the various conventionally printed product packages. This testing and viewing of the product along with its associated data (e.g., cost, quantity, productivity, etc.) can assist the buyer to select the most appropriate package printing at any point in the product's life cycle. The mock-up may be product economically in small volume samples using digital printing. Eventually, larger volume product packages could be produced using conventional contact printing processes.

Other uses may also be realized. For example, embodiments of the present invention can provide supplemental small quantities of digitally printed packages. These digitally printed packages could supplement conventionally printed packages when additional packages are needed (e.g. in the interim until the next conventional production run or for make-up production to replace packages damaged during a finishing or fulfillment step).

The principles, exemplary embodiments, and modes of operation of the present invention have been described in the foregoing description. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit and scope of the present invention. Accordingly, it is expressly intended that all such variations, changes, and equivalents fall within the spirit and scope of the present invention, as claimed. For example, although embodiments of the present invention has been described with reference to several specific editing operations that can be carried out in accordance with the present invention, embodiments of the present invention are not limited to just these operations. Rather, embodiments of the present invention can be employed with any desired editing or processing operation that a user might want to carry out to achieve the desired proof appearance. Further, although examples have been described as being implemented in an exemplary embodiment with the Abode Photoshop® software package, one skilled in the art would recognize that aspects of the present invention may be implemented with other desktop publishing software programs, such as Adobe PageMaker®, Adobe Illustrator®, QuarkXPress™, available from Quark, Inc. Denver Colo.; CorelDraw® and other packages available from Corel Corp., Ottawa, Ontario; or independently of such software. Also, it will be appreciated that filters that simulate other printing categories, such as digital printing methods, may also be practiced with the present invention.

The embodiments of the invention in which an exclusive property or privilege is claimed are defined as follows:

1. A method of generating proof data, the proof data to be used to digitally print a product proof, comprising:
obtaining a digital image; and
applying at least one digital filter to the digital image, wherein the digital filter alters the digital image to simulate at least one appearance effect indicative of a printing process.

2. The method of claim 1, wherein the printing process is a contact printing process or a digital printing process.

3. The method of claim 2, wherein the contact printing process is selective from the group consisting of flexography, lithography, and gravure.

4. The method of claim 1, wherein the at least one appearance effect is selected from the group consisting of mottling, ink squeeze out, and washboarding.

5. The method of claim 1, further including
processing the digital image prior to or after applying the digital filter.

6. The method of claim 5, wherein processing the digital image includes making color adjustments.

7. The method of claim 5, wherein processing the digital image includes simulating the appearance of the substrate to be used for the final product.

8. The method of claim 7, wherein the simulation includes simulating substrate color and substrate type.

9. The method of claim 5, wherein processing the digital image includes making at least one image reproduction adjustment.

10. The method of claim 9, wherein the image reproduction adjustment is selected from the group consisting of half tone screen frequency, screen angles, rosette pattern, moiré patterns, anti-aliasing, misregistration and trapping.

11. A method for generating a product proof on a digital output device, comprising:
obtaining a digital image;
selecting at least one digital filter to apply to the digital image based on selected criteria; and
filtering the digital image by the selected at least one filter to alter the digital image for creating proof data, wherein the proof data includes at least one print appearance attribute of contact printing.

12. The method of claim 11, wherein the criteria is selected from the group consisting of substrate type, ink type, printing method, and combinations thereof.

13. The method of claim 11, wherein the at least one digital filter to be selected is selected from a group of filters consisting of a mottling, a ink squeeze out, and a washboarding filter.

14. The method of claim 11, further comprising
printing the proof data on a selected substrate to generate the product proof.

15. The product proof generated from the method of claim 14.

16. A method of utilizing a digital prepress workflow to aid in customer decision making, comprising:
obtaining one or more customer design parameters associated with a print job;
generating a source image according to at least one of the customer parameters;
generating a set of modified images from the source image by applying one or more filters to the source image, wherein each modified image of the set simulates the at least one print appearance affect of printing on a selected output device that is different than the output device chosen for generating the set of proofs; and
printing the modified images as a set of proofs on the chosen digital printing device.

17. The method of claim 16, wherein the selected output device is a contact printing device.

18. The method of claim 16, wherein the customer design parameters are parameters selected from the group consisting of colors, metallic appearance preference, packaging type, printing method, and proof substrate.
